(19) United States
(12) Patent Application Publication
(10) Pub. No.: US 2010/0255329 A1
(43) Pub. Date: Oct. 7, 2010

(54) COPOLYMERS(S) LATEX, METHOD FOR PREPARING SAME AND USE THEREOF FOR COATING PAPER AND CARTON

(75) Inventor: Laurence Couvreur, Paris (FR)

Correspondence Address: ARKEMA INC.;PATENT DEPARTMENT - 26TH FLOOR, 2000 MARKET STREET, PHILADELPHIA, PA, 19103-3222, US

(73) Assignee: Arkema France, Colombes (FR)

(21) Appl. No.: 12/670,071

(22) PCT Filed: Jul. 24, 2008
(86) PCT No.: PCT/FR08/51390

§ 371 Date: Jun. 17, 2010

(30) Foreign Application Priority Data
Jul. 25, 2007 (FR) 0756723

(51) Int. Cl. C08F 2/38; B32B 27/10

(52) U.S. Cl. 428/511; 526/222

(57) ABSTRACT

The invention relates to copolymer(s) latexes prepared from vinylic monomers, non-conjugated dienes and optionally comonomers, particularly acrylic ones, in the presence of at least one chain transfer agent of the following formula.

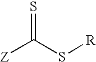

These latexes are particularly well-suited for coating paper and cardboard.

The present invention relates to latices of copolymer(s) manufactured using chain transfer agents or molecular weight regulators, which are free of halogens and which may be used for paper coating applications, in particular in the sector of odor-sensitive applications (for example food packaging).

The latices which can be used for coating paper and board must have good mechanical properties (printability, pick resistance of the coating). For this purpose, it is necessary to control the molecular weight of the latices of copolymer(s) during the polymerization using chain transfer agents (CTA) or regulators.

In the past, organohalogenated compounds were widely used as chain transfer agents (for example carbon tetrachloride, carbon tetrabromide), then they were banned some years ago for ecological reasons and replaced with mercaptan-type sulfur-containing transfer agents, and especially by tert-dodecylmercaptan (TDM).

Mercaptans carry out their role as regards action on the control of the molecular weight of the chains in the latices of copolymer(s) very well and make it possible to obtain latices which have a good dry or wet pick resistance. However, the major drawback of mercaptans is their very strong and undesirable odor which persists not only in the latices but also in the paper and/or board made with such latices, which restricts their use and their development in the field of paper and board.

Other technical solutions have therefore been proposed:

U.S. Pat. No. 5,837,762 describes the use of chain transfer agents derived from rosin for the manufacture of latices of copolymer(s). However, the regulating efficiency of rosin is much lower than those of mercaptans. It is therefore necessary to use up to 9% of rosin during the polymerization of the latex in order to achieve acceptable values of dry pick resistance of the coated paper. Moreover, rosin is a natural product, the quality of which varies greatly depending on the origin. Finally, it should be mentioned that rosin has an inherent strong coloration (from yellow to brown) which may be a drawback in coated paper, given the amounts of rosin that are used.

FR 2 665 450 describes a very large family of organosulfur transfer agents which are substituted diphenyl disulfides and used as transfer agents for the preparation of a low-odor latex since they exhibit no or very little undesirable residual odor. However, this patent indicates that diphenyl disulfide alone is not effective enough as a CTA and that other organic disulfides, known to be molecular weight regulators, such as thiuram disulfide, diethylxanthogen disulfide and diphenyl disulfides substituted by amines. These additives are for the most part known as retarders and produce undesirable odors. The amounts of transfer agents recommended in the patent for the polymerization are between 0.5% and 10%, with an optimum between 0.5% and 5% in order to obtain a paper that has satisfactory properties (printability, pick resistance of the coating), similar to paper treated with obtained with TDM.

JP 7166496, JP 7278213 and JP 2001/003298 describe the use of an α-methylstyrene dimer, alone or as a mixture, as a transfer agent for latices for coated paper applications. However, due to the fact that these products are not very effective, amounts much greater than those customarily used must be employed in order to arrive at good final properties of the materials.

EP 1 380 597 describes the use of several types of peroxides used as chain transfer agents (such as di-tert-butyl peroxide, cumyl hydroperoxide, or di-tert-butyl hydroperoxide, etc.). However, the amount of peroxides used must be two times greater than the amounts of TDM in order to obtain quasi-similar performances (particle size, glass transition temperature (Tg), gel content and intrinsic properties of the coated paper). Nothing is indicated as regards the odor of the product.

U.S. Pat. No. 6,369,158 claims the use of dibenzyl trithiocarbonate (DBTTC) for the synthesis of a latex of SBR type (styrene-butadiene rubber) of high molecular weight which is predominantly used in tire applications. It is well known that these elastomer-type products are characterized by low glass transition temperatures that are incompatible with applications in which elastomer-type products are not desired.

The problem faced is to search for variants of regulator systems that do not contain halogen, that do not have an odor that is as undesirable and strong as that of mercaptans while being suitable for manufacturing latices of copolymer(s) having a sufficient bond strength (that is to say pick resistance) and which may thus be used in the sector of odor-sensitive applications for the coating of paper and board.

One subject of the invention is a latex of copolymer(s) intended to be used for the coating of paper and board, where the latex of copolymer(s) has a glass transition temperature between −30° C. and 70° C., preferably between −20° C. and 40° C., manufactured with at least one chain transfer agent and comprising, in polymerized form:
a) from 10% by weight to 80% by weight of one or more vinyl monomers;
b) from 20% by weight to 70% by weight of one or more conjugated diene monomers;
c) and optionally up to 70% by weight of one or more monomers comprising at least one copolymerizable ethylenically unsaturated group, chosen from acrylic monomers, ethylene-type unsaturated dicarboxylic acid monomers, monomers that also bear at least one nitrile functional group, vinyl ester monomers and (meth)acrylamide monomers;
   characterized in that the at least one chain transfer agent may be represented by the formula:

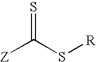

where R is chosen from —CH₂R1, —CHR1R′1 and —CR1R′1R″1, in which R1, R′1 and R″1, which are identical or different, each represent, independently of one another, a group chosen from an optionally substituted alkyl, an optionally substituted saturated, unsaturated or aromatic carbocyclic or heterocyclic ring, an optionally substituted alkylthio, an optionally substituted alkoxy group, an optionally substituted dialkylamino, an organometallic group, acyl, acyloxy, carboxy (and its esters and/or salts), sulfonic acid (and its salts and/or sulfonates), alkoxycarbonyl or aryloxycarbonyl, and a polymer chain prepared by any polymerization mechanism;

where Z is chosen from hydrogen, halogen (chlorine, bromine, iodine), an optionally substituted alkyl, an optionally substituted aryl, an optionally substituted heterocycle, an optionally substituted alkylthio —SR (R being as defined above), an optionally substituted alkoxycarbonyl, an optionally substituted aryloxycarbonyl (—COOR2), a carboxy (—COOH), an optionally substituted acyloxy (—OCOR2), an optionally substituted carbamoyl (—CONHR2, —CONHR2R3), a cyano (—CN), a dialkylphosphonato or diarylphosphonato [—P(═O)OR2₂], a dialkylphosphinato or diarylphosphinato [—P(═O)R2₂], a polymer chain prepared by any polymerization mechanism, an —OR2 group and an —NR2R3 group;

where R2 and R3, which are identical or different, are chosen from the group constituted of C₁ to C₁₈ alkyl, C₂ to C₁₈ alkenyl, C₆ to C₁₈ aryl, heterocyclyl, aralkyl or alkaryl, each of these groups possibly being optionally substituted and in which the substituents are chosen from epoxy, hydroxy, alkoxy, acyl, acyloxy, carboxy (and its esters and/or salts), sulfonic acid (and its salts and/or sulfonates), alkoxycarbonyl or aryloxycarbonyl, isocyanato, cyano, silyl, halo and dialkylamino.

The group R as defined above may be released in the form of a radical R*, which initiates the free-radical polymerization.

Among the chain transfer agents, mention may especially be made of dithioesters (compounds comprising at least one —C(═S)S— unit), dithiocarbonates or xanthates (compounds comprising at least one —O—C(═S)S— unit), dithiocarbamates (compounds comprising at least one —N—C(═S)S— unit) and trithiocarbonates (compounds comprising at least one —S—C(═S)S— unit).

Dithioesters which may advantageously be used in the context of the invention are those corresponding to the formula (I) below:

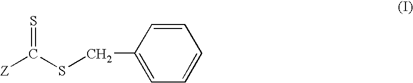

in which Z represents a group chosen from —C₆H₅, —CH₃, a pyrrol group, —OC₆F₅, a pyrrolidinone group, —OC₆H₅, —OC₂H₅, —N(C₂H₅)₂ and advantageously the group —S—CH₂—C₆H₅ (dibenzyl trithiocarbonate or DBTTC) of formula (II) below:

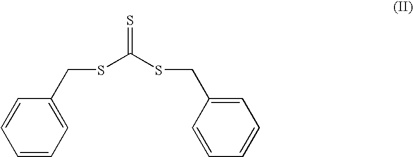

The chain transfer agents as defined above and which are liposoluble and are not or not very water-soluble are very particularly preferred. The transfer agent of formula (II) corresponds very particularly to these conditions.

Regarding chain transfer agents, dibenzyl trithiocarbonate (DBTTC) and its derivatives are very particularly suitable.

The amounts of chain transfer agents used in general range from 0.1 to 10% by weight, preferably from 0.1 to 5% by weight, particularly from 0.1 to 3% by weight, relative to 100% by weight of monomer(s) a) to c).

The amounts of chain transfer agents above allow the synthesis of a latex of copolymer(s), of which the free copolymer(s) (fractions extracted from the isolated copolymer(s) at ambient temperature by toluene, over 24 hours) have the following characteristics:
5 000≦Mₙ≦80 000, preferably 5 000≦Mₙ≦50 000,

and 10 000≦M_{w}≦270 000, preferably 10 000≦M_{w}≦200 000,

where Mₙ and M_{w} respectively represent the number-average molecular weight and weight-average molecular weight.

Quite surprisingly, it has been discovered that the amounts used of the chain transfer agents defined above may be lower than those used with the chain transfer agents conventionally employed (mercaptans, dithiols and trithiols, etc.) while retaining the mechanical properties of the copolymers (such as bond strength, pick resistance, etc.).

The vinyl monomers a) comprise, in particular, vinyl aromatic monomers such as styrene, α-methylstyrene, para-ethylstyrene, tert-butylstyrene and/or vinyltoluene. Mixtures of one or more vinyl monomers may also be used. The preferred monomers are styrene and α-methylstyrene. The monomer or monomers a) are used in general in a range that extends from 10% to 80% by weight, preferably from 25% to 75% by weight, most of the time preferably from 35% to 70% by weight, relative to the total weight of the monomers.

The conjugated diene monomers b) suitable for the manufacture of the latices include conjugated diene monomers such as, for example, 1,3-butadiene, isoprene and 2,3-dimethyl-1,3-butadiene. 1,3-butadiene is preferred in the present invention. Typically, the amount of conjugated diene monomer(s) present in the polymer phase ranges from 20% to 70% by weight, preferably from 20% to 65% by weight, more preferably from 20% to 55% by weight, more preferably from 30% to 50% by weight, most of the time from 30% to 45% by weight, relative to the total weight of the monomers.

The acrylic monomers c) that can be used in the present invention as copolymerizable comonomers include, in particular, acrylic acid, methacrylic acid, alkyl (meth)acrylates, hydroxyalkyl (meth)acrylates and/or alkoxyalkyl (meth)acrylates where the alkyl group (n-alkyl, iso-alkyl or tert-alkyl) possesses from 1 to 20 alkyl carbon atoms and is optionally substituted by at least one epoxy or amide group and/or at least one amine group; the reaction product of (meth)acrylic acid with the glycidyl ester of a neo acid such as versatic acids, neodecanoic acids or pivalic acid and mixtures thereof.

The preferred acrylic monomers are acrylic acid, methacrylic acid, alkyl (meth)acrylates and/or hydroxyalkyl (meth)acrylates and/or alkoxyalkyl (meth)acrylates, where the alkyl group is a C₁-C₁₀, advantageously C₁-C₈ alkyl group. By way of example of preferred acrylic monomers, mention may particularly be made of acrylic acid, methacrylic acid, n-butyl acrylate, sec-butyl acrylate, ethyl acrylate, hexyl acrylate, tert-butyl acrylate, 2-ethylhexyl acrylate, isooctyl acrylate, 4-methyl-2-pentyl acrylate, 2-methylbutyl acrylate, methyl methacrylate, butyl methacrylate, n-butyl methacrylate, isobutyl methacrylate, ethyl methacrylate, isopropyl methacrylate, hexyl methacrylate, cyclohexyl methacrylate, cetyl methacrylate, methoxyethyl methacrylate, ethoxyethyl acrylate, butoxyethyl methacrylate, methoxybutyl acrylate, methoxyethoxyethyl acrylate, hydroxyethyl acrylate, hydroxypropyl acrylate, hydroxyethyl methacrylate, hydroxypropyl methacrylate and/or hydroxybutyl acrylate.

The acrylic monomers that are very particularly preferred are acrylic acid, methacrylic acid, butyl acrylate, 2-ethylhexyl acrylate and methyl methacrylate.

Typically, the amount of acrylic monomer(s) optionally present in the polymer phase depends on the monomer or monomers chosen; however, the typical range may extend up to 70% by weight, preferably may range from 1 to 70% by weight, advantageously from 1 to 60% by weight, most of the time preferably from 0 to 51% by weight, relative to the total weight of the monomers.

The ethylene-type unsaturated dicarboxylic acid monomers that can be used as copolymerizable comonomers c) in the context of the present invention comprise, besides the ethylenically unsaturated dicarboxylic acids, their monoesters and/or their anhydrides. As examples of ethylene-type unsaturated dicarboxylic acid monomers, mention may be made of fumaric acid, crotonic acid, maleic acid and maleic acid anhydride.

The nitrile monomers that can be used as copolymerizable comonomers c) within the context of the present invention comprise polymerizable unsaturated aliphatic nitrite monomers that contain from 2 to 4 carbon atoms in a linear or branched arrangement and which may be optionally substituted by an acetyl group or supplementary nitrile groups. These nitrile monomers comprise, for example, acrylonitrile, methacrylonitrile and fumaronitrile, acrylonitrile being preferred. These nitrite monomers (when they are used) may be included up to around 25 parts by weight, preferably from 0 to 15 parts by weight, relative to 100 parts by weight of monomers.

The vinyl ester monomers that can be used as copolymerizable monomers c) comprise vinyl acetate, vinyl propionate, vinyl butyrate, vinyl benzoate, vinyl 2-ethylhexanoate, vinyl stearate and vinyl esters of versatic acid. The vinyl ester monomer preferred for use in the present invention is vinyl acetate. Typically, the amount of vinyl ester monomer (when it is used) which is present in the polymer phase ranges from 0 to 45% by weight, preferably from 0 to 35% by weight, relative to the total weight of the monomers.

The (meth)acrylamide monomers that can be used as copolymerizable monomers c) comprise the amides of α,β-olefin-unsaturated carboxylic acids such as for example acrylamide, methacrylamide and diacetone acrylamide. The preferred (meth)acrylamide monomer is acrylamide. Typically, the amount of (meth)acrylamide monomer (when it is used) which is present in the polymer phase depends on the monomer chosen, but the typical range extends however from 0 to 10% by weight, preferably from 0 to 5% by weight, most preferably from 0 to 2% by weight relative to the total weight of the monomers.

Another subject of the invention is a process for manufacturing a latex of copolymer(s) as defined previously, starting from:
A/ from 10% by weight to 80% by weight of one or more vinyl monomers a);
B/ from 20% by weight to 70% by weight of one or more conjugated diene monomers b);
C/ optionally up to 70% by weight of one or more copolymerizable monomers c) chosen from acrylic monomers, ethylene-type unsaturated dicarboxylic acid monomers, nitrile monomers, vinyl ester monomers and (meth)acrylamide monomers; and
D/ at least one chain transfer agent (CTA) represented by the formula:

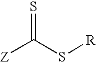

where R and Z are as defined previously,

at temperatures of 0° C. to 130° C., preferably from 20° C. to 130° C., more preferably from 60° C. to 130° C., particularly from 60° C. to 100° C. and very particularly from 75° C. to 100° C.,

in the presence of one or more emulsifiers or surfactants and/or one or more initiators and/or one or more protective colloids and/or one or more agents such as anti-foaming agents, wetting agents, thickeners, plasticizers, fillers, pigments, crosslinking agents, antioxidants and metal chelating agents.

The size or average diameter of the latex particles, measured by light scattering, is in general between 50 and 200 nm.

The composition of the latex of copolymer(s) of the present invention may be manufactured according to polymerization processes which are known in the field of polymerization, and in particular according to latex emulsion polymerization processes, especially latex polymerizations carried out with seed latices. The representative processes include those which are described in documents U.S. Pat. No. 4,478,974, U.S. Pat. No. 4,751,111, U.S. Pat. No. 4,968,740, U.S. Pat. No. 3,563,946 and U.S. Pat. No. 3,575,913 and DE-A-19 05 256. These processes may be, where appropriate, suitable for the polymerization of the monomers described previously. The process for introducing monomers and other ingredients such as polymerization additives is not particularly critical. The polymerization is then carried out under standard conditions, until the desired degree of polymerization is obtained. The crosslinking agents and the additives well known for the polymerization of latex such as initiators, surfactants and emulsifiers may be used depending on the requirements.

The initiators that can be used within the context of the present invention include water-soluble and/or liposoluble initiators, which are effective for the purposes of polymerization. The representative initiators are well known in the professional field and include, for example, azo compounds (such as, for example AIBN) and persulfates (such as for example potassium persulfate, sodium persulfate and ammonium persulfate).

The initiator or initiators are used in a sufficient amount to initiate the creation of polymerization at a desired rate; in general, an amount of initiator of 0.05 to 5% by weight, preferably of 1 to 4% by weight, relative to the weight of the total polymer is sufficient. Advantageously, the amount of initiator reaches from 0.1 to 3% by weight, relative to the total weight of the polymer.

Among the suitable surfactants or emulsifiers, it is possible to use any type of customary surfactant known in the field of polymerization processes. The surfactant or surfactants may be added to the aqueous phase and/or to the phase of the monomer or monomers. The amount of surfactant(s) is in general chosen in order to favor the stabilization of the particles in colloid form and/or to reduce contact between the particles and/or to prevent coagulation. In an unseeded process, the amount of surfactant(s) is in general chosen in order to influence the particle size of the particles.

As examples of surfactants, mention may be made of ethylenically saturated and unsaturated sulfonic acids or salts thereof, including for example hydroxycarboxylic/sulfonic acids, such as vinylsulfonic acid, allylsulfonic acid and methallylsulfonic acid, and salts thereof; aromatic hydroxycarboxylic acids such as for example para-styrenesulfonic acid, iso-propenylbenzenesulfonic acid and vinyloxybenzenesulfonic acid and salts thereof; the sulfoalkyl esters of acrylic acid and of methacrylic acid, such as for example sulfoethyl methacrylate and sulfopropyl methacrylate and salts thereof, and also 2-acrylamido-2-methylpropanesulfonic acid and salts thereof; alkyl diphenyl oxide disulfonates, sodium dodecylbenzenesulfonates and dihexyl esters of sodium sulfosuccinic acid, ethoxylated alkylphenols and ethoxylated alcohols; and fatty alcohol (poly)ether sulfates.

The type and the concentration of surfactant(s) typically depend on the content of solid polymers: a higher content of solid polymers generally increases the need for surfactant(s). Typically, the surfactant(s) are used at concentrations ranging from 0.05 to 20, preferably from 0.05 to 10, more preferably from 0.05 to 5 parts by weight, relative to the total weight of the monomers.

Various protective colloids may also be used instead of or in addition to the surfactants which have just been described. Suitable colloids include partially acetylated polyvinyl alcohol, casein, hydroxyethylated starch, carboxymethyl cellulose, hydroxyethyl cellulose, hydroxypropyl cellulose and gum arabic; the preferred protective colloids are carboxymethyl cellulose, hydroxyethyl cellulose and hydroxypropyl cellulose. In general, these protective colloids are used at contents ranging from 0 to 10, preferably from 0 to 5, more preferably from 0 to 2 parts by weight, relative to the total weight of the monomers.

Various other additives, known to a person skilled in the art in the field of polymerization, may be incorporated in order to manufacture the latex composition of the present invention. These additives comprise, for example, anti-foaming agents, wetting agents, thickeners, plasticizers, fillers, pigments, crosslinking agents, antioxidants and metal chelating agents. Known anti-foaming agents include silicone oils and acetylene glycols. The customary known wetting agents include alkylphenol ethoxylates, alkali metal dialkylsulfosuccinates, acetylene glycols and alkali metal alkylsulfates. Typical thickeners include polyacrylates, polyacrylamides, xanthan gums, modified cells or particulate thickeners such as diatomaceous earths and clays. Typical plasticizers include mineral oil, liquid polybutenes, liquid polyacrylates and lanolin. Zinc oxide, titanium dioxide, aluminum hydrate and calcium carbonate and clay are the fillers that are typically used.

Another subject of the invention is the use of the latices of copolymer(s) defined previously for the coating of paper and board.

It has been found that latices of copolymer(s) comprising at least one ethylene-type unsaturated carboxylic acid monomer, whether it is an acrylic monomer and/or whether it is an ethylene-type unsaturated dicarboxylic acid monomer, greatly improves the stability of the latex and the adhesion of the latex films, which makes the latices particularly suitable for their use in paper coating formulations. For the practical implementation of the present invention, it is preferred to use ethylene-type unsaturated aliphatic monocarboxylic or dicarboxylic acid(s) or acid anhydride(s) that contain from 3 to 5 carbon atoms. Examples of monocarboxylic acid monomers include, for example: acrylic acid and methacrylic acid and examples of dicarboxylic acid monomers include, for example: fumaric acid, crotonic acid, maleic acid and maleic acid anhydride.

As indicated above, the use of ethylenically unsaturated carboxylic acid monomer(s) influences the properties of the polymer dispersion and of the coatings which are manufactured therefrom, typically when the amount of ethylenically unsaturated carboxylic acid monomer(s) ranges from 1 to 20% by weight, preferably from 1 to 10% by weight, relative to the total weight of the monomers.

According to one preferred embodiment, the composition of the latex of copolymer(s) of the present invention prepared from styrene, butadiene and acrylic acid, preferably copolymerized in the presence of DBTTC as a chain transfer agent.

The following examples illustrate the invention.

Unless otherwise indicated, the amounts and percentages are expressed by weight.

### EXAMPLE 1 (COMPARATIVE)

### Styrene Latex

Procedure for the Batch Mode Emulsion Polymerization of Styrene at 65° C.
A solution is prepared that contains 0.24 g of HCO₃Na (buffer), 8 g of SLS (Sodium Lauryl Sulfate) surfactant and 540 g of distilled water; the mixture is stirred and heated (approximately 50° C.) until the surfactant is completely dissolved.
The transfer agent (DBTTC or TDM)/monomer (styrene) mixture is prepared, the CTA being introduced in the proportions indicated in table 1 below.
Introduction of the two mixtures above into a 1-L jacketed reactor previously put under vacuum, with stirring at 150 rpm, and that is heated at 65° C.
The medium is depleted of oxygen with three cycles of putting under vacuum then under nitrogen in order to inert the reactor, it is left under vacuum at 65° C. before introduction of the initiator.
A solution containing the initiator, namely 0.2 g of PRS in 15 g of water (i.e. 82.6 mol % of PRS relative to the DBTTC) is prepared.
This mixture is introduced into an air lock under a purge of nitrogen then injected into the reactor via a pressure of nitrogen; the air lock is rinsed with 45 g of water, still under nitrogen, which is injected into the reactor.
The pressure of the reactor is then adjusted to 0.15 MPa with nitrogen. This moment is considered to be the polymerization start time T=0. The to conversion is monitored by sample withdrawals that are immediately cooled in ice and the solids content of which is tested using a thermobalance at 140° C. (Mettler Toledo HB43).
The polymerization is stopped at the end of three hours. The samples withdrawn are dried in a ventilated oven overnight at 100° C.
The dried polymers are analyzed by size exclusion chromatography (SEC) in THF at 40° C. at 1 g/l with a flow rate of 1 mL/min on a set of two Pigel MIXED B columns (30 cm) with a refractive index detector and UV detector. The results of the molecular weights and distribution are expressed as polystyrene (PS) equivalents.
The sizes of the particles and distribution of the final latex are measured using a Malvern Zetameter (Zetasizer 5000).

For each test, a latex of copolymer(s) is obtained for which the nature and amount of CTA used (in % relative to the monomers), the degree of conversion (measured by solids content), the number-average molecular weight measured by SEC with polystyrene calibration and the polydispersity index M_{w}/Mₙ are given in table 1 below.

TABLE 1

| | Type of | | Degree of | Mₙ^{b} | |
|---|---|---|---|---|---|
| Test | CTA | CTA (%) | conversion^{a} | (g · mol⁻¹) | M_{w}/Mₙ^{b} |
| 1 | — | 0 | 0.95 | 1 100 000 | >>2.6^{c} |
| 2 | TDM | 0.18 | 0.95 | 110 000 | 2.4 |
| 3 | DBTTC | 0.13 | 0.97 | 190 000 | 1.8 |
| 4 | DBTTC | 0.26 | 0.94 | 150 000 | 1.7 |

^{a}By solids content;
^{b}By SEC polystyrene equivalents;
^{c}due to the presence of large mass/gels

### EXAMPLE 2

### Styrene/Butadiene/Acrylic Acid Latex

Procedure for the Semi-Continuous Mode Emulsion Synthesis of Styrene/Butadiene at 80° C. and 50% Solids Content
Prepared previously in a vessel refrigerated at −18° C. is 300 g of butadiene originating from a cylinder of 1,3-butadiene gas at ambient temperature. This step known as a “distillation” step makes it possible to obtain liquid butadiene via cooling.
Introduced (just before the start of the polymerization) into a vessel under vacuum at ambient temperature, equipped with a relief valve set at 1.2 MPa and placed on a balance, is the mixture of the following monomers (an excess of 50 g is provided):
303.3 g of styrene/24.1 g of acrylic acid and chain transfer agent (DBTTC or TDM) in the amounts indicated in table 2 below.
The vessel is again put under vacuum and the liquid butadiene vessel is pressurized with nitrogen (0.3 MPa). The balance, with the vessel containing the monomers tared is, and then 209.5 g of butadiene are introduced.
This vessel containing the monomers is then pressurized to 1 MPa with nitrogen.
The butadiene vessel is degassed by flushing with nitrogen and the cooling thereof is stopped.
The following mixture is prepared, which is introduced into a 1-L jacketed reactor at 50° C., under vacuum and with stirring at 150 rpm:
205 g water/0.03 g EDTA/1.55 g NaOH in aqueous solution at a concentration of 25 wt %/3.97 g SLS at a concentration of 29.7 wt %.
The reactor is again put under vacuum and then introduced into the reactor, by weighing after taring the balance with the vessel, are 30% of the monomers, i.e. the equivalent of 82.5 g of styrene/57.1 g of butadiene/6.6 g of acrylic acid/1.21 g of DBTTC.
The reactor is heated up to 80° C. and the initiator is prepared with 1.46 g of Na₂S₂O₈ and 15 g of water.
At 80° C., the initiator is introduced, under N₂, via an air lock then the air lock is rinsed with 20 g of water that are also introduced into the medium. The pressure is then close to 0.57 MPa.
The polymerization is left to start so as to have a “seed”, a drop in the pressure of 0.02 MPa is observed over around 30 minutes.
Then, introduced simultaneously into the reactor for a semi-continuous mode over two hours are the following three mixtures:

a) introduced via a micro limit valve, with a flow rate of 2.9 g/min, over two hours, are 70% of the monomers of the vessel, i.e. 192.5 g of styrene/133 g of butadiene/15.3 g of acrylic acid and 2.83 g of DBTTC;

b) also introduced, via a valve pump, at a flow rate of 1.08 mL/min, over two hours, is a mixture containing 3.41 g of Na₂S₂O₈ topped up to 120 g with water, followed by rinsing the line with 10 g of water;

c) also introduced, via a valve pump, at a flow rate of 1.1 mL/min, over two hours, is the mixture containing 110 g of water/3.73 g of NaOH in aqueous solution at a concentration of 25 wt %/9.28 g of SLS at a concentration of 29.7 wt % followed by rinsing the line with 10 g of water.
At the end of the addition in semi-continuous mode, the pressure is 0.73 MPa, a sample (5 to 10 g) is then withdrawn after rinsing the reactor outlet valve, into a flask equipped with a septum and containing a “polymerization-stopping agent” i.e. 0.1 to 0.2 g of a 1.5 wt % solution of sodium dithiocarbamate in water. The conversion is then measured via the solids content using a Mettler Toledo HB43 thermobalance (conversion=43%).
The polymerization is left to continue for 2 h (P=0.55 MPa) and the sample withdrawal is repeated as indicated previously also with a measurement of the conversion (74%).
After an additional 1 h 30 min (P=0.39 MPa), the same operation is repeated, the conversion is then 95%.
The reaction is then stopped with introduction into the reactor, under N₂, via the air lock, of 10 g of a 1.5% solution of sodium dithiocarbamate in water.
The reactor is then degassed and the heating set point is lowered to 20° C., mixing is continued for 15 to 30 minutes then the latex is removed under the exhaust ventilation of the fume hood. The flask is left open under exhaust ventilation overnight in order to degas the residual butadiene.
The reactor is cleaned with water at 70° C. then with THF at 50° C., then it is dried and disassembled for manual cleaning. The vessel containing residual monomers is degassed and cleaned by rinsing with acetone.

Characterizations of the SBAA Latex Obtained:

Particle Size

The distribution in the final latex is measured using a Malvern Zetameter (Zetasizer 5000) after diluting the latex in order to adjust it to the concentration required for the measurement cell of the apparatus. The particle sizes can also be measured by CHDF. Typically, values are obtained of 171 nm measured using the Zetasizer and 156 nm via CHDF.

Preparation of the Latex Film

The final crude latex is placed in polytetrafluoroethylene cups (70 mm in diameter) so as to have 6 to 7 g of dry product: around 14 g of latex is sampled per cup, the latex being left to dry slowly by evaporation under a fume hood for three days. Then the drying is continued in a ventilated oven at 50° C. for one day. The film obtained is carefully lifted off and turned over for an additional drying of one day still in an oven at 50° C.

Low Temperature Coagulation of the Latex

At −10° C. for 24 hours after having diluted it to 115^{th}. 20 g of crude latex is taken which is diluted with 80 g of water. Next it is defrosted, then it is washed and it is “settled/filtered” in order to recover as best possible the coagulated latex in a crystallizer. It is dried in an oven at 50° C. for 24 h, then it is “lifted off” from the crystallizer in order to turn it upside down and again dry it for 24 h at 50° C.

Measurement of the T_{g} (Glass Transition Temperature)

From the latex film and the coagulated latex using a Mettler DSC30. Sampling of 60 to 70 mg in the crucible. Measurement of the T_{g} after two passes from −100 to +150° C. at a rate of 10° C./min. A latex film T_{g}=2.3° C. and a coagulated latex T_{g}=−1.6° C. are obtained. The glass transition temperature is indicated in the form of an inflexion point on the DSC curve.

Content of Free Polymer

This corresponds to the amount of polymer dissolved in toluene after extracting at high temperature in a Soxhlet extractor for 24 h. Approximately 3 g of latex film or of coagulated latex are weighed with an accuracy to 10⁻⁴ g and placed in a Soxhlet thimble (Durieux model for an extractor with dimensions of 37×130 mm). Underneath the Soxhlet extractor, a 500 ml flask is filled with toluene that is brought to reflux for 24 h. The free polymer thus extracted is recovered in the flask containing the toluene.

The amount of free polymer is measured from the difference in the weight of the thimble after having first dried it in an oven at 120° C. overnight and leaving it at ambient temperature during the day (moisture uptake). A percentage of free polymer equal to 53% is obtained for the latex film and of 100% for the coagulated latex.

Example of the Calculation for a Test with DBTTC:

| | | Coagulated |
|---|---|---|
| Mass weighed (g) | Latex film | latex |
| Tare weight of the empty thimble | 13.536 | 12.4513 |
| Mass of latex (approx. 3 g) | 3.0559 | 3.1286 |
| Mass of thimble (tare weight + dry latex) after | 14.9604 | 12.4557 |
| 24 h extraction with toluene and drying | | |
| at 120° C. overnight | | |
| Dry mass: (mass of thimble − thimble tare | 1.4244 | 0.0044 |
| weight) | | |
| % free polymer: 100 × (latex mass − dry | 53.39 | 99.86 |
| mass)/latex mass | | |

Gel Content and Swelling Index

The measurement of the gel content is used to determine the insoluble fraction of a polymer in a given solvent and the crosslinking of the latex of copolymer(s). It corresponds to the gel portion of the polymer that is not dissolved in toluene after 24 h at low temperature. As solvent, toluene is then used. The swelling is carried out on films which were manufactured as described above. The gel that is insoluble in toluene is separated by filtration, dried and weighed. The gel content is defined as being the quotient of the weight of the dried gel divided by the weight of the original latex film (before swelling with toluene) and is expressed in %.

0.5 g of latex film or coagulated latex cut into very small pieces is weighed with an accuracy to 10⁻⁴ g in a metal basket that has a width of 25 mm and a height of 60 mm and a very fine mesh (50 μm opening with a wire of 40 μm). This basket is submerged in a 100 mL beaker containing 75 mL of toluene, at ambient temperature under a bell jar in toluene-saturated air, the swollen polymer is then left for 24 h. The basket is removed from the toluene and left to drain for one hour, it is weighed and this measurement gives the swelling index; an index of 26 is obtained for the latex film and an index of 17 is obtained for the coagulated latex.

The basket is then dried overnight in a ventilated oven at 120° C. The weight of the dried basket gives the value of the gel content of the polymer that has not been dissolved in toluene. This gives, for the latex film, a gel content of 37% and for the coagulated latex a content of 1%.

Example of the Calculation for a Test with DBTTC

| | | Coagulated |
|---|---|---|
| Mass weighed | Latex film | latex |
| basket no. | 1 | 2 |
| P1 (tare weight of empty basket) | 22.496 | 22.5035 |
| P2 (tare weight of wet basket after 30′ in | 22.8273 | 22.7444 |
| toluene) | | |
| P3 (tare weight + approx. 0.5 g of latex) | 22.9987 | 22.9969 |
| P4 (after 24 h swelling in toluene and drained | 27.5878 | 22.821 |
| for 1 h) | | |
| P5 (dry basket after drying overnight at | 22.68 | 22.508 |
| 120° C.) | | |
| Swelling index: (P4 − P2)/(P5 − P1) | 25.87 | 17.02 |
| % gel content: 100 × (P5 − P1)/(P3 − P1) | 36.60 | 0.91 |

Molecular Weights and Distribution Via Size Exclusion Chromatography (SEC)

Using gel permeation chromatography (GPC), it is possible to determine the molecular weight of the polymers on condition that the polymers dissolve completely in the solvent used (here THF).

In PTFE cups, the free polymer (previously extracted into toluene after refluxing for 24 h in the Soxhlet extractor) is recovered by evaporation of the toluene in a ventilated oven at 50° C. for two days. The weights and distribution are determined by size exclusion chromatography (SEC) in THF at 40° C. and at 1 g/L with a flow rate of 1 mL/min on a set of two Pigel MIXED B (30 cm) columns with a refractive index detector and a UV detector. The results of the molecular weights and distribution are expressed as PS equivalents.

The following are thus obtained:

| | Mₙ | M_{w} | |
|---|---|---|---|
| | (g · mol⁻¹) | (g · mol⁻¹) | M_{w}/Mₙ |
| free polymer after 24 h extraction with | 11 800 | 52 000 | 4.4 |
| toluene from the latex film | | | |
| free polymer after 24 h extraction with | 20 300 | 156 000 | 7.7 |
| toluene from the coagulated latex | | | |

For each test, a film is obtained for which the nature and the amount of CTA used (in % relative to the monomers), the degree of conversion (measured by solids content), the glass transition temperature (T_{g}), the gel content, the number-average molecular weight Mₙ measured by SEC with polystyrene calibration and the polydispersity index M_{w}/Mₙ, are given in table 2 below.

TABLE 2

| | Type | | Degree | Ø of the | | Gel | | |
|---|---|---|---|---|---|---|---|---|
| | of CTA | Polymerization | of | particles | T_{g} | content | Mₙ^{b} | |
| Test | (%) | time (h) | conversion ^{a} | (nm) | (° C.) | (%) | (g · mol⁻¹) | M_{w}/Mₙ^{b} |
| 5 | TDM | 4.5 | 0.95 | 146 | 1.5 | 69 | 8 800 | >12.3^{c} |
| | (1.14) | | | | | | | |
| 6 | DBTTC | 6 | 0.95 | 171 | 2.3 | 47 | 11 800 | 4.4 |
| | (0.82) | | | | | | | |
| 7 | DBTTC | 4.5 | 0.96 | 158 | 11.7 | 0.75 | 13 400 | 7.6 |
| | (0.41) | | | | | | | |

^{a}By solids content;
^{b}By SEC polystyrene equivalents;
^{c}due to the presence of large mass/gels

1. A latex of copolymer(s) having a glass transition temperature between −30° C. and 70° C., manufactured with at least one chain transfer agent and comprising, in polymerized form:
a) from 10% by weight to 80% by weight of one or more vinyl monomer units;
b) from 20% by weight to 70% by weight of one or more conjugated diene monomer units;
c) and optionally up to 70% by weight of one or more monomer units comprising at least one copolymerizable ethylenically unsaturated group, chosen from acrylic monomers, ethylene-type unsaturated dicarboxylic acid monomers, monomers that also bear at least one nitrile functional group, vinyl ester monomers and (meth)acrylamide monomers;
wherein the at least one chain transfer agent may be represented by the formula: 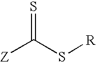
where R is chosen from —CH₂R1, —CHR1R′1 and —CR1R′1R″1, in which R1, R′1 and R″1, which are identical or different, each represent, independently of one another, a group chosen from an optionally substituted alkyl, an optionally substituted saturated, unsaturated or aromatic carbocyclic or heterocyclic ring, an optionally substituted alkylthio, an optionally substituted alkoxy group, an optionally substituted dialkylamino, an organometallic group, acyl, acyloxy, carboxy (and its esters and/or salts), sulfonic acid (and its salts and/or sulfonates), alkoxycarbonyl or aryloxycarbonyl, and a polymer chain prepared by any polymerization mechanism;
where Z is chosen from hydrogen, (chlorine, bromine, iodine), an optionally substituted alkyl, an optionally substituted aryl, an optionally substituted heterocycle, an optionally substituted alkylthio —SR (R being as defined above), an optionally substituted alkoxycarbonyl, an optionally substituted aryloxycarbonyl (—COOR2), a carboxy (—COON), an optionally substituted acyloxy (—OCOR2), an optionally substituted carbamoyl (—CONHR2, —CONHR2R3), a cyano (—CN), a dialkylphosphonato or diarylphosphonato [—P(═O)OR2₂], a dialkylphosphinato or diarylphosphinato [—P(═O)R2₂], a polymer chain prepared by any polymerization mechanism, an —OR2 group and an —NR2R3 group;
where R2 and R3, which are identical or different, are chosen from the group constituted of C₁ to C₁₈ alkyl, C₂ to C₁₈ alkenyl, C₆ to C₁₈ aryl, heterocyclyl, aralkyl or alkaryl, each of these groups possibly being optionally substituted and in which the substituents are chosen from epoxy, hydroxy, alkoxy, acyl, acyloxy, carboxy (and its esters and/or salts), sulfonic acid (and its salts and/or sulfonates), alkoxycarbonyl or aryloxycarbonyl, isocyanato, cyano, silyl, halo and dialkylamino.

2. The latex of copolymer(s) as claimed in claim 1, wherein the at least one chain transfer agent is chosen from dithioesters, dithiocarbonates or xanthates, dithiocarbamates and/or trithiocarbonates, and preferably comprises dibenzyl trithiocarbonate (DBTTC).

3. The latex of copolymer(s) as claimed in claim 1, wherein the amount of at least one chain transfer agent used ranges from 0.1 to 10% by weight, relative to 100% by weight of monomers) a) to c).

4. The latex of copolymer(s) as claimed in claim 1, of which the free copolymer(s) (fractions extracted from the isolated copolymer(s) at ambient temperature by toluene, over 24 hours) have the following characteristics:
5 000 Mₙ≦80 000,
and 10 000≦M_{w}≦270 000,
where Mₙ and M_{w} respectively represent the number-average molecular weight and weight-average molecular weight.

5. The latex of copolymer(s) as claimed in claim 1, wherein the vinyl monomer or monomers a) are chosen from styrene, α-methylstyrene, para-ethylstyrene, tert-butylstyrene and/or vinyltoluene, and preferably from styrene and/or α-methylstyrene.

6. The latex of copolymer(s) as claimed in claim 1, wherein the conjugated diene monomer or monomers b) are chosen from 1,3-butadiene, isoprene and 2,3-dimethyl-1,3-butadiene and preferably 1,3-butadiene.

7. The latex of copolymer(s) as claimed in claim 1, wherein the acrylic monomer or monomers c) are chosen from acrylic acid, methacrylic acid, alkyl (meth)acrylates, hydroxyalkyl (meth)acrylates and/or alkoxyalkyl (meth)acrylates where the alkyl group (n-alkyl, iso-alkyl or tent-alkyl) possesses from 1 to 20 alkyl carbon atoms and is optionally substituted by at least one epoxy, amine or amide group and/or at least one amine group; the reaction product of (meth)acrylic acid with the glycidyl ester of a neo acid such as versatic acids, neodecanoic acids, pivalic acid and mixtures thereof, and preferably acrylic acid, methacrylic acid, butyl acrylate, 2-ethylhexyl acrylate and methyl methacrylate.

8. The latex of copolymer(s) as claimed in claim 1, wherein the average diameter of the latex particles, measured by light scattering, is between 50 and 200 nm.

9. A process for manufacturing a latex of copolymer(s) as claimed in claim 1, comprising polymerizing a mixture of:
A/ from 10% by weight to 80% by weight of one or more vinyl monomers a);
B/ from 20% by weight to 70% by weight of one or more conjugated diene monomers b);
C/ optionally up to 70% by weight of one or more copolymerizable monomers c) chosen from acrylic monomers, ethylene-type unsaturated dicarboxylic acid monomers, nitrile monomers, vinyl ester monomers and (meth)acrylamide monomers; and
D/ at least one chain transfer agent (CTA) represented by the formula: 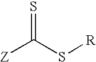
where R and Z are as defined in claim 1,
at temperatures of 0° C. to 130° C.,
in the presence of one or more emulsifiers or surfactants and/or one or more initiators and/or one or more protective colloids and/or one or more agents such as anti-foaming agents, wetting agents, thickeners, plasticizers, fillers, pigments, crosslinking agents, antioxidants and metal chelating agents.

10. A coated paper or cardboard, comprising a paper or cardboard having directly coated thereon the latex of copolymers of claim 1.

11. The latex of copolymer(s) of claim 1, wherein said copolymer has a glass transition temperature between −20° C. and 40° C.

12. The latex of copolymer(s) of claim 3, wherein the amount of at least one chain transfer agent used ranges from 0.1 to 5% by weight, relative to 100% by weight of monomer(s) a) to c).

13. The latex of copolymer(s) of claim 12, wherein the amount of at least one chain transfer agent used ranges from 0.1 to 3% by weight, relative to 100% by weight of monomer(s) a) to c).

14. The latex of copolymer(s) as claimed in claim 4, of which the free copolymer(s) (fractions extracted from the isolated copolymer(s) at ambient temperature by toluene, over 24 hours) have the following characteristics:
5 000≦Mₙ≦50 000,
and 10 000≦M_{w}≦200 000,
where Mₙ and M_{w} respectively represent the number-average molecular weight and weight-average molecular weight.

14. The coated paper or cardboard of claim 10, wherein said coating comprises styrene, butadiene, acrylic acid or DBTTC as a chain transfer agent

15. The process for manufacturing a latex of copolymer(s) as claimed in claim 9 wherein the polymerization temperature is from 20° C. to 130° C.

16. The process for manufacturing a latex of copolymer(s) as claimed in claim 15 wherein the polymerization temperature is from 60° C. to 130° C.,

17. The process for manufacturing a latex of copolymer(s) as claimed in claim 16 wherein the polymerization temperature is from 75° C. to 100° C.
